(19) United States
(12) Patent Application Publication
(10) Pub. No.: US 2020/0100150 A1
(43) Pub. Date: Mar. 26, 2020

(54) Enhancements to s-Measure Configuration

(71) Applicant: Telefonaktiebolaget LM Ericsson (publ), Stockholm (SE)

(72) Inventors: Icaro L. J. da Silva, Solna (SE); Pradeepa Ramachandra, Linköping (SE)

(21) Appl. No.: 16/302,027

(22) PCT Filed: Sep. 6, 2018
(86) PCT No.: PCT/SE2018/050892

§ 371 Date: Nov. 15, 2018

Related U.S. Application Data
(60) Provisional application No. 62/554,805, filed on Sep. 6, 2017.

(51) Int. Cl. H04W 36/00; H04W 24/10; H04B 17/327; H04W 24/02; H04W 24/08; H04W 76/10; H04W 76/28

(52) U.S. Cl. CPC H04W 36/0088; H04W 24/10; H04W 36/0094; H04W 76/28; H04W 24/02; H04W 24/08; H04W 76/10; H04B 17/327

(57) ABSTRACT

A wireless device receives (502, 902) a parameter indicating a threshold value associated with signal measurements performed using a reference signal type among reference signal types that the wireless device can measure or using a measurement signal quantity among measurement signal quantities that can be determined by the wireless device. The wireless device performs (504) a signal measurement on transmissions from a serving cell using the reference signal type or performs (904) measurements of the measurement signal quantity on the transmissions, to obtain a signal measurement value. The wireless device determines (506, 906) whether to perform measurements on transmission from neighbor cells, based on whether the signal measurement value is below the threshold value. If the signal measurement value is below the threshold value, the wireless device performs (508, 908) configured measurements on transmissions from neighbor cells, using reference signal types or measurement signal quantities based on configured measurement event triggers.

### TECHNICAL BACKGROUND

The present disclosure is generally related to wireless communications systems, and is more particularly related to wireless devices that perform signal measurements using multiple types of reference signals.

### BACKGROUND

In the specifications developed by members of the 3rd-Generation Partnership Project (3GPP) for so-called Long-Term Evolution (LTE) wireless communications system, the concept of s-Measure has been introduced, to reduce the neighbor cell measurement overhead for a wireless device, referred to in 3GPP documentation as a user equipment (UE). For example, when primary cell (PCell) measurements performed by the UE are above a network-configured s-Measure value, the UE refrains from performing the neighboring cell measurements.

3GPP TS 36.331, v12.14.0 (June 2017) specifies the Radio Resource Control (RRC) protocol for LTE radio access, which is referred to by 3GPP as Evolved Universal Terrestrial Radio Access (E-UTRA), when the LTE radio access network (Evolved Universal Terrestrial Radio Access Network, or E-UTRAN) configures a measurement, an information element (IE) called “MeasConfig” specifies measurements to be performed by the UE. That IE includes the “s-Measure” parameter, which is defined by the standard as follows:
PCell quality threshold controlling whether or not the LE is required to perform measurements of intra frequency, inter-frequency and inter-RAT neighbouring cells. Value “0” indicates to disable s-Measure.

In this same specification, the following procedural text describes the UE actions related to s-Measure:

5.5.2 Measurement Configuration

. . .
1>if the received measConfig includes the s-Measure:
   2>set the parameter s-Measure within VarMeasConfig to the lowest value of the RSRP ranges indicated by the received value of s-Measure;

. . .

5.5.3 Performing measurements
The UE shall:

. . .
1>for each measId included in the measIdList within VarMeasConfig:
   2>if the purpose for the associated reportConfig is set to reportCGI:

. . .
2>if the ul-DelayConfig is configured for the associated reportConfig

. . .
2>else:
   3>if a measurement gap configuration is setup; or
   3>if the UE does not require measurement gaps to perform the concerned measurements:
      4>if s-Measure is not configured; or
      4>if s-Measure is configured and the PCell RSRP, after layer 3 filtering, is lower than this value; or

. . .
4>if the ue-RxTxTimeDiffPeriodical is configured in the associated reportConfig:
5>perform the UE Rx-Tx time difference measurements on the PCell;
4>if the reportSSTD-Meas is set to true in the associated reportConfig:
5>perform SSTD measurements between the PCell and the PSCell;
4>if the measRSSI-ReportConfig is configured in the associated reportConfig:
5>perform the RSSI and channel occupancy measurements on the frequency indicated in the associated measObject;
2>perform the evaluation of reporting criteria as specified in 5.5.4;

In LTE, the network can thus configure an s-Measure parameter so that the UE is only required to perform neighbor cell measurements when its PCell Reference Signal Received Power (RSRP), after L3 filtering, goes below that value. A similar concept has been agreed upon by 3GPP for the forthcoming 5th-Generation wireless network under development, which includes a radio access technology often referred to as “New Radio” or “NR.” However, in LTE, PCell RSRP is calculated based only on cell-specific reference signals (RS). In NR, on the other hand, PCell RSRP can be calculated either based on a Synchronization Signal Block (SSB) or a Channel State Information reference signal (CSI-RS). This means that changes to UE behaviors are needed.

### SUMMARY

In 3GPP discussions, it has been proposed that a single s-Measure threshold be defined for NR, while other proposals seek to define multiple s-Measure thresholds, e.g., one per reference signal (RS) type, such as one s-Measure threshold for SSB measurements and another s-Measure threshold for CSI-RS measurements. However, no UE operations have been established with respect to neighbor cell measurements and it has not been determined how these single or multiple thresholds could be configured and/or used by the UE.

Another limitation in the LTE solution is that the network can only configure s-Measure in association with RSRP measurements, despite the fact that the UE already performs both RSRP and Reference Signal Received Quality (RSRQ) measurements on the PCell and then triggers events based on RSRP or RSRQ. It will be appreciated that RSRP measurements can be understood as reflecting signal “coverage,” while RSRQ measurements better reflect the “quality” of the received signals. Hence, the UE is currently required to perform neighbor cell measurements only based on a drop in coverage of the PCell, while events could be triggered based on quality and/or coverage.

Embodiments of the present invention involve configuring thresholds and UE operations to solve the abovementioned problems. In various embodiments, the network can configure the UE with a single configurable threshold or multiple s-Measure thresholds. In one group of embodiments, s-Measure can be associated with one or multiple RS Types. The UE then operates according to configurations related to neighbor cell measurements.

According to some embodiments, a method in a wireless device includes receiving a first parameter indicating a first threshold value, where the first threshold value is associated with signal measurements performed using a first reference signal type of a plurality of reference signal types that the wireless device can measure. The method also includes performing a signal measurement on transmissions from a serving cell, using the first reference signal type, to obtain a first signal measurement value. The method further includes determining whether to perform measurements on transmission from neighbor cells, based on whether the first signal measurement value is below the first threshold value, and, responsive to determining that the first signal measurement value is below the first threshold value, performing configured measurements on transmission from one or more neighbor cells, using one or more of the plurality of reference signal types based on one or more configured measurement event triggers.

In another group of embodiments, an s-Measure can be associated with one or multiple measurement quantity(ies) such as RSRP, RSRQ, signal-to-noise-plus-interference ration (SINR), or any link coverage or link quality quantities. This can be done for a given RS Type (configurable or fixed) or for multiple RS Types. The UE then operates according to configurations related to neighbor cell measurements.

According to some embodiments, then, a method in a wireless device includes receiving a first parameter indicating a first threshold value, where the first threshold value is associated with signal measurements performed using a first reference signal quantity of a plurality of measurement signal quantities that can be determined by the wireless device. The method also includes performing a signal measurement of the first measurement signal quantity on transmissions from a serving cell, to obtain a first signal measurement value. The method further includes determining whether to perform measurements on transmission from neighbor cells, based on whether the first signal measurement value is below the first threshold value, and, responsive to determining that the first signal measurement value is below the first threshold value, performing configured measurements on transmission from one or more neighbor cells, using one or more of the plurality of reference signal quantities based on one or more configured measurement event triggers.

The different configuration possibilities allow the network to relax the UE requirements for when the UE shall start performing neighbor cell measurements. For example, if the handover function at the network makes handover decisions based on the quality of serving and neighbor cells, where the quality is based on both CSI-RS and SS Block measurement quantities, the UE shall not be required to perform neighbor cell measurements only when its SS Block measurement results degrade. Instead, neighbor cell measurements will be performed only when both the SS Block and CSI-RS degrade. This would minimize the UE's measurement efforts.

In another example, if the handover function at the network makes handover decisions based on RSRQ and RSRP of serving and neighbor cells (even for a given RS type, such as SSB), the UE shall not be required to perform neighbor cell measurements only when its RSRP degrades, but only when both RSRP and RSRQ degrade. This would also minimize the UE's measurement efforts.

According to some embodiments, a wireless device includes transceiver circuity configured for receiving transmissions and processing circuitry operatively associated with the transceiver circuitry. The processing circuitry is configured to receive a first parameter indicating a first threshold value, where the first threshold value is associated with signal measurements performed using a first reference signal type of a plurality of reference signal types that the wireless device can measure. The processing circuitry is configured to perform a signal measurement on transmissions from a serving cell, using the first reference signal type, to obtain a first signal measurement value. The processing circuitry is also configured to determine whether to perform measurements on transmission from neighbor cells, based on whether the first signal measurement value is below the first threshold value, and, responsive to determining that the first signal measurement value is below the first threshold value, perform configured measurements on transmission from one or more neighbor cells, using one or more of the plurality of reference signal types based on one or more configured measurement event triggers.

According to some embodiments, a wireless device includes transceiver circuity configured for receiving transmissions and processing circuitry operatively associated with the transceiver circuitry. The processing circuitry is configured to receive a first parameter indicating a first threshold value, where the first threshold value is associated with signal measurements performed using a first reference signal quantity of a plurality of measurement signal quantities that can be determined by the wireless device. The processing circuitry is configured to perform a signal measurement of the first measurement signal quantity on transmissions from a serving cell, to obtain a first signal measurement value. The processing circuitry is further configured to determine whether to perform measurements on transmission from neighbor cells, based on whether the first signal measurement value is below the first threshold value, and, responsive to determining that the first signal measurement value is below the first threshold value, perform configured measurements on transmission from one or more neighbor cells, using one or more of the plurality of reference signal quantities based on one or more configured measurement event triggers.

According to some embodiments, a non-transitory computer readable medium stores a computer program comprising computer instructions that, when executed by a processor of a wireless device, causes the wireless device to receive a first parameter indicating a first threshold value, where the first threshold value is associated with signal measurements performed using a first reference signal type of a plurality of reference signal types that the wireless device can measure. The instructions cause the wireless device to perform a signal measurement on transmissions from a serving cell, using the first reference signal type, to obtain a first signal measurement value. The instructions also cause the wireless device to determine whether to perform measurements on transmission from neighbor cells, based on whether the first signal measurement value is below the first threshold value, and, responsive to determining that the first signal measurement value is below the first threshold value, perform configured measurements on transmission from one or more neighbor cells, using one or more of the plurality of reference signal types based on one or more configured measurement event triggers.

According to some embodiments, a non-transitory computer readable medium stores a computer program comprising computer instructions that, when executed by a processor of a wireless device, causes the wireless device to receive a first parameter indicating a first threshold value, where the first threshold value is associated with signal measurements performed using a first reference signal quantity of a plurality of measurement signal quantities that can be determined by the wireless device. The instructions cause the wireless device to perform a signal measurement of the first measurement signal quantity on transmissions from a serving cell, to obtain a first signal measurement value. The instructions cause the wireless device to determine whether to perform measurements on transmission from neighbor cells, based on whether the first signal measurement value is below the first threshold value, and, responsive to determining that the first signal measurement value is below the first threshold value, perform configured measurements on transmission from one or more neighbor cells, using one or more of the plurality of reference signal quantities based on one or more configured measurement event triggers.

Further aspects of the present invention are directed to an apparatus, computer program products or computer readable storage medium corresponding to the methods summarized above and functional implementations of the above-summarized apparatus and wireless device.

Of course, the present invention is not limited to the above features and advantages. Those of ordinary skill in the art will recognize additional features and advantages upon reading the following detailed description, and upon viewing the accompanying drawings.

### BRIEF DESCRIPTION OF THE FIGURES

FIG. 1 illustrates a signal flow graph according to some embodiments when s-Measure is configured by the network and is applicable to the RS Type as specified in a standard.

FIG. 2 illustrates a signal flow graph according to some embodiments when s-Measure and the corresponding RS Type is configured by the network.

FIG. 3 illustrates a signal flow graph according to some embodiments when multiple s-Measures and their corresponding applicable RS Types are configured by the network.

FIG. 4 is a block diagram of a wireless device, according to some embodiments.

FIG. 5 illustrates a method in the wireless device, according to some embodiments.

FIG. 6 illustrates an embodiment where a single s-Measure is configured and the applicable RS Type is standard specified.

FIG. 7 illustrates an embodiment where a single s-Measure is configured and the applicable RS Type is also configured.

FIG. 8 illustrates an embodiment where different s-Measures are configured for the different RS Types.

FIG. 9 illustrates another method in the wireless device, according to some embodiments.

FIG. 10 is a block diagram of a network node, according to some embodiments.

FIG. 11 is a block diagram illustrating a functional implementation of a wireless device, according to some embodiments.

FIG. 12 is a block diagram illustrating another functional implementation of a wireless device, according to some embodiments.

### DETAILED DESCRIPTION

As discussed in the background section above, in LTE, PCell RSRP is calculated based only on cell-specific reference signals (RS). In NR, however, PCell RSRP can be calculated either based on a Synchronization Signal (SS) Block or a Channel State Information reference signal (CSI-RS). In 3GPP discussions, it has been proposed that a single s-Measure threshold be defined for NR, while other proposals seek to define multiple s-Measure thresholds, e.g., one per reference signal (RS) type, such as one s-Measure threshold for SSB measurements and another s-Measure threshold for CSI-RS measurements. However, no UE operations have been established with respect to neighbor cell measurements and it has not been determined how these single or multiple thresholds could be configured and/or used by the UE.

Another limitation in the LTE solution is that the network can only configure s-Measure in association with RSRP measurements, despite the fact that the UE performs both RSRP and Reference Signal Received Quality (RSRQ) measurements on the PCell and can trigger events based on RSRP or RSRQ. It will be appreciated that RSRP measurements can be understood as reflecting signal “coverage,” while RSRQ measurements better reflect the “quality” of the received signals. Hence, with the approach specified in the LTE standards, the UE is required to perform neighbor cell measurements based only on a drop in coverage of the PCell, even though events could be triggered based on quality and/or coverage.

Embodiments of the present invention involve configuring thresholds and UE operations to solve the abovementioned problems. In various embodiments, the network can configure the UE with a single configurable threshold or with multiple thresholds. The s-Measure discussed herein is an example of these configurable thresholds. In one group of embodiments, an s-Measure can be associated with one or multiple RS Types. The UE then operates according to configurations related to neighbor cell measurements.

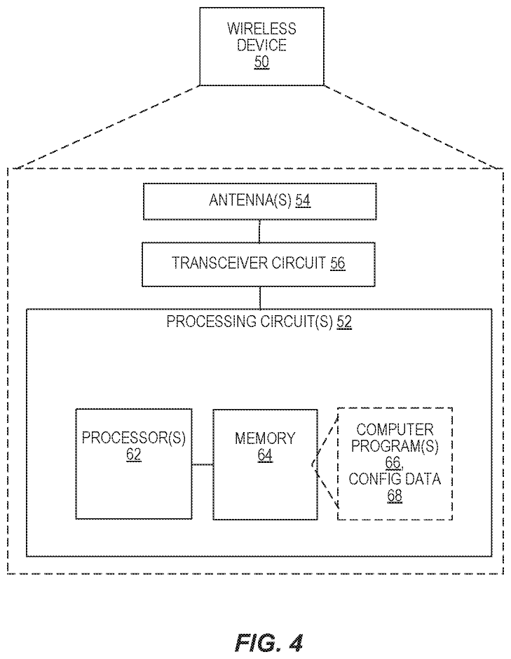

FIG. 4 illustrates a diagram of a wireless device, shown as wireless device 50, according to some embodiments. The wireless device 50 may be considered to represent any wireless terminals that may operate in a network, such as a UE in a cellular network. Other examples may include a communication device, target device, device to device (D2D) UE, machine type UE or UE capable of machine to machine communication (M2M), a sensor equipped with UE, PDA (personal digital assistant), Tablet, mobile terminal, smart phone, laptop embedded equipped (LEE), laptop mounted equipment (LME), USB dangles, Customer Premises Equipment (CPE), etc.

The wireless device 50 is configured to communicate with a radio network node or base station in a wide-area cellular network via antennas 54 and a transceiver circuit 56. The transceiver circuit 56 may include transmitter circuits, receiver circuits, and associated control circuits that are collectively configured to transmit and receive signals according to a radio access technology, for the purposes of using cellular communication services. This radio access technology is NR for the purposes of this discussion, but it will be appreciated that the presently disclosed techniques and apparatuses are not limited to the NR radio access technology.

The wireless device 50 also includes one or more processing circuits 52 that are operatively associated with the radio transceiver circuit 56. The processing circuit 52 comprises one or more digital processing circuits, e.g., one or more microprocessors, microcontrollers, Digital Signal Processors (DSPs), Field Programmable Gate Arrays (FPGAs), Complex Programmable Logic Devices (CPLDs), Application Specific Integrated Circuits (ASICs), or any mix thereof. More generally, the processing circuit 52 may comprise fixed circuitry, or programmable circuitry that is specially adapted via the execution of program instructions implementing the functionality taught herein, or may comprise some mix of fixed and programmed circuitry. The processing circuit 52 may be multi-core.

The processing circuit 5:2 also includes a memory 64. The memory 64, in some embodiments, stores one or more computer programs 66 and, optionally, configuration data 68. The memory 64 provides non-transitory storage for the computer program 66 and it may comprise one or more types of computer-readable media, such as disk storage, solid-state memory storage, or any mix thereof. Here, “non-transitory” means permanent, semi-permanent, or at least temporarily persistent storage and encompasses both long-term storage in non-volatile memory and storage in working memory, e.g., for program execution. By way of non-limiting example, the memory 64 comprises any one or more of SRAM, DRAM, EEPROM, and. FLASH memory, which may be in the processing circuit 52 and/or separate from processing circuit 52. The memory 64 may also store any configuration data 68 used by the user equipment 50. The processing circuit 52 may be configured, e.g., through the use of appropriate program code stored in memory 64, to carry out one or more of the methods and/or signaling processes detailed hereinafter.

The processing circuit 52 of the wireless device 50 is configured, according to some embodiments, to perform signal measurements using a first reference signal type of a plurality of reference signal types that the wireless device can measure. The processing circuit 52 is configured to receive a first parameter indicating a first threshold value, where the first threshold value being associated with signal measurements performed using the first reference signal type. This first threshold value may be an “s-Meaure,” in some embodiments. The processing circuit 52 is also configured to perform a signal measurement on transmissions from a serving cell, using the first reference signal type, to obtain a first signal measurement value, and determine whether to perform measurements on transmission from neighbor cells, based on whether the first signal measurement value is below the first threshold value. The processing circuit 52 is configured to, responsive to determining that the first signal measurement value is below the first threshold value, perform configured measurements on transmission from one or more neighbor cells, using one or more of the plurality of reference signal types based on one or more configured measurement event triggers.

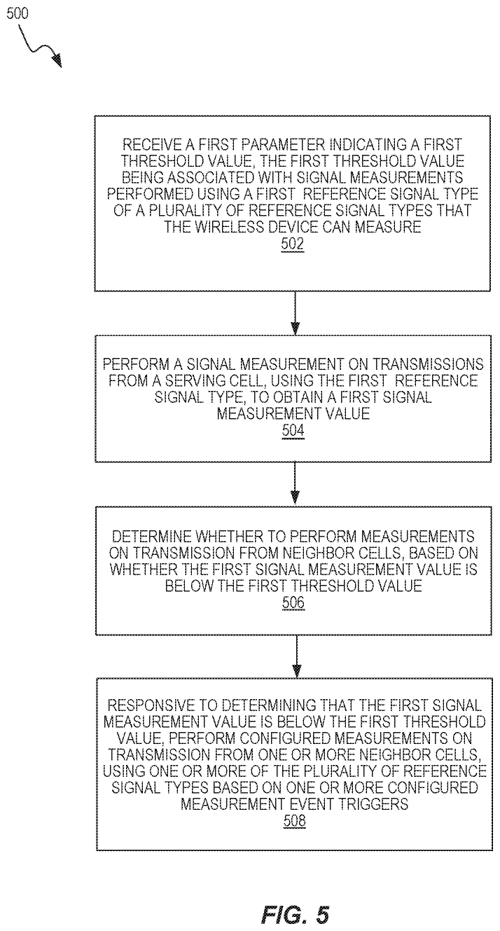

According to some embodiments, the processing circuit 52 is configured to perform a corresponding method 500, as shown in FIG. 5. The method 500 includes receiving a first parameter indicating a first threshold value, the first threshold value being associated with signal measurements performed using a first reference signal type of a plurality of reference signal types that the wireless device can measure (block 502). Again, this first threshold value may be an s-Measure, in some embodiments. The method 500 also includes performing a signal measurement on transmissions from a serving cell, using the first reference signal type, to obtain a first signal measurement value (block 504). The method 500 further includes determining whether to perform measurements on transmission from neighbor cells, based on whether the first signal measurement value is below the first threshold value (block 506) and, responsive to determining that the first signal measurement value is below the first threshold value, performing configured measurements on transmission from one or more neighbor cells, using one or more of the plurality of reference signal types based on one or more configured measurement event triggers (block 508). The signal measurement quantities include at least a reference signal received power signal quantity and a reference signal received power quantity.

In some cases, performing configured measurements on transmission from one or more neighbor cells includes performing measurements using a different one of the plurality of reference signal types from the first reference signal type. The plurality of reference signal types may include cell-specific reference symbols and synchronization signals. That is, the wireless device can do these measurements on different reference signal types. This corresponds to, for example, performing the PCell measurement using CSI-RS, but then measuring neighbor cells using NR-SS, when the PCell measurement is less than the s-Measure.

The first parameter may apply to any of a plurality of signal measurement quantities that can be determined by the wireless device. In this case, it does not matter what signal measurement quantity is used.

The first parameter may also apply to a first signal measurement quantity of a plurality of signal measurement quantities that can be determined by the wireless device. Here, the threshold's-Measure applies only to a specific quantity (as well as to a specific RS Type).

The method 500 may further include receiving, prior to performing the signal measurement on transmissions from the serving cell, configuration information indicating the applicability of the first parameter to the first signal measurement quantity and/or configuration information indicating the first reference signal type associated with the first parameter.

In some embodiments, the method 500 may further include receiving a second parameter indicating a second threshold value, where the second threshold value is associated with signal measurements performed using a second reference signal type of the plurality of reference signal types that the wireless device can measure. In these embodiments, the method further includes performing a signal measurement using the second reference signal type on transmissions from a serving cell, to obtain a second signal measurement value, and the performing the configured measurements on transmission from one or more neighbor cells shown in block 508 is responsive to determining both that the first signal measurement value is below the first threshold value and that the second signal measurement value is below the second threshold.

In the following example embodiments, RSRP or RSRQ are used as examples of measurement quantities, and an s-Measure parameter is used as an example of the “threshold parameter” discussed in the above embodiments. However, the methods described herein may more generally comprise the usage of any measurement quantity, e.g., RSRP, RSRQ, SINR, etc., and the threshold parameters may be referred to as something other than an s-Measure. In some embodiments, combinations of RSRP and RSRQ measurements are disclosed; however, similar combinations may include any measurement quantities, e.g., RSRP, RSRQ and SINR.

Single s-Measure per RS Type (Fixed or Configurable)

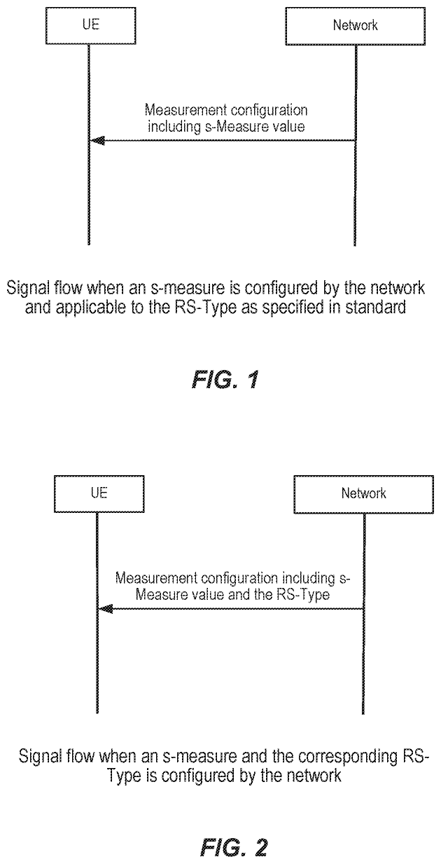

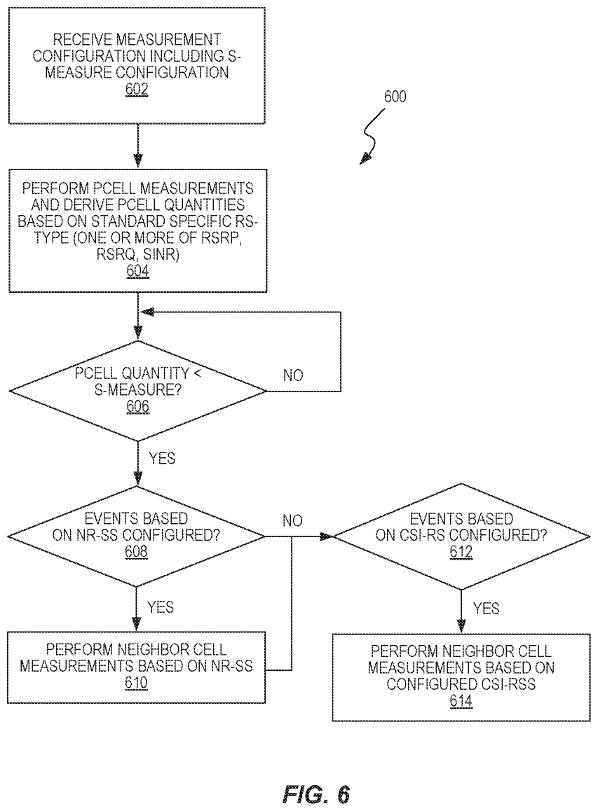

In a first example embodiment, a single s-Measure parameter is defined by a relevant industry specification and is always associated with the same single RS Type. The RS Type can be an NR-SS or a reference signal that is always transmitted for a given measurement object, such as an RS transmitted in the SSB. Alternatively, the RS Type can be a CSI-RS or a reference signal that is configured for a given UE per cell per measurement object. The corresponding network configuration signal flow graph is given in FIG. 1 and the corresponding flow chart of UE actions is provided in FIG. 6.

As seen in block 602 of FIG. 6, the UE receives a measurement configuration include an s-Measure configuration. Based on this received measurement configuration, the UE shall perform PCell measurements and derive PCell quantities based on the standard-specific reference signal type. The PCell quantity may be an RSRP or any other trigger quantity, e.g., RSRQ, SINR, etc., of the serving cell performed on that single RS type (e.g., NR-SS on PCell) with the configured s-Measure (block 604). The PCell quantity is then compared to the s-Measure, as shown at block 606. If that measurement result is below the configured s-Measure, the UE shall start neighbor cell measurements according to the configured RS Types in the configured reportConfig(s) linked to measurement objects. If all configured events are based on RS Type=NR-SS (decision 608), the UE shall start measuring NR-SS (block 610). Otherwise, if all configured events are based on RS Type=CSI-RS (decision 612), the UE shall start to perform measurements based on CSI-RS (block 614). Else, if there are events based on RS Type=NR-SS and events based on RS Type=CSI-RS, the UE shall perform measurements based on NR-SS and CSI-RS.

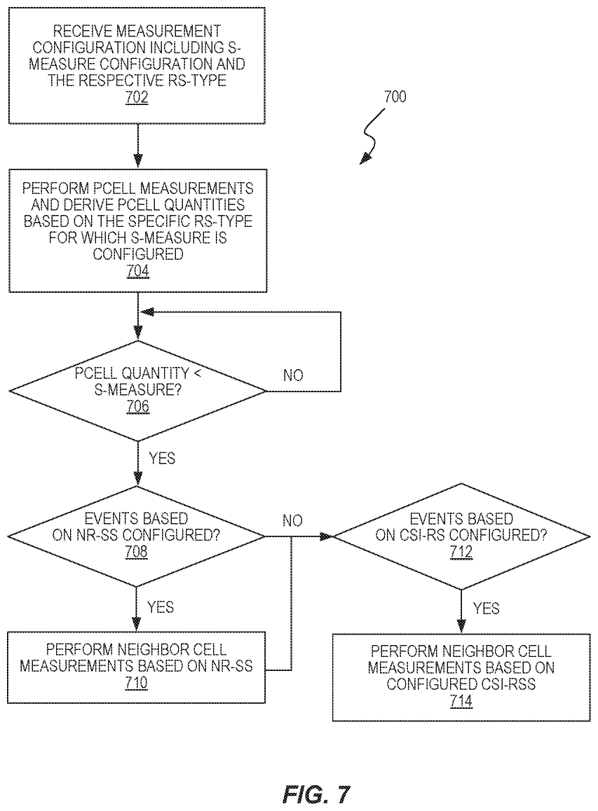

In a second example embodiment, the association between the single s-Measure and a single RS Type is configurable. That is, the network can configure an s-Measure threshold value and configure an RS Type associated to it. The corresponding network configuration signal flow graph is given in FIG. 2 and the corresponding flow chart of UE actions is provided in FIG. 7.

For example, the network can provide an s-Measure value and set a parameter RS Type for s-Measure=NR-SS based on the configuration (block 702). Upon that configuration, the UE shall compare the RSRP (or any other trigger quantity such as RSRQ, SINR, etc.) of the serving cell performed on that configured RS type (e.g., NR-SS on PCell) (block 704) with the configured s-Measure (decision 706). If that measurement result is below the configured s-Measure, the UE shall start neighbor cell measurements according to the configured RS Types in the configured reportConfig(s) linked to measurement objects. If all configured events are based on RS Type=NR-SS (decision 708), the UE shall start measuring the NR-SS (block 710). Otherwise, if all configured events are based on RS Type=CSI-RS (decision 712), the UE shall start to perform measurements based on CSI-RS (block 714). Else, if there are events based on RS Type=NR-SS and events based on RS Type=CSI-RS, the UE perform measurements based on NR-SS and CSI-RS.

Single s-Measure per Measurement Quantity (Fixed or Configurable)

In a third example embodiment, a single fixed s-Measure parameter is defined by the relevant industry specifications and is always associated with the same measurement quantity. That measurement quantity can be RSRP, RSRQ, SINR, or any other metric reflecting radio link/cell coverage or radio link quality. The corresponding network configuration signal flow graph is also shown by FIG. 1. The flow of this process is similar to that shown by FIG. 6. Based on the configuration, the UE shall compare the measurement results associated to that measurement quantity (e.g. RSRP) of the serving cell with the configured s-Measure and, if that measurement result (e.g. RSRP) is below the configured s-Measure, the UE shall start neighbor cell measurements according to the configured RS Types in the configured reportConfig(s) linked to measurement objects. If all configured events are based on RS Type=NR-SS, the UE shall start measuring NR-SS. Otherwise, if all configured events are based on RS Type=CSI-RS, the UE shall start to perform measurements based on CSI-RS. Else, if there are events based on RS Type=NR-SS and events based on RS Type=CSI-RS the UE shall perform measurements based on NR-SS and CSI-RS.

In a fourth example embodiment, the association between the single s-Measure and a measurement quantity is configurable. That is, the network can configure an s-Measure threshold value and configure a measurement quantity associated with it. For example, the network can provide an s-Measure value and set a parameter measurement quantity for s-Measure =RSRQ. This signal flow is also shown by FIG. 2. Upon that configuration, similar to what is shown by the flowchart of FIG. 7, the UE shall compare the RSRQ of the serving cell with the configured s-Measure. If that RSRQ value is below the configured s-Measure, the UE shall start neighbor cell measurements according to the configured RS Types in the configured reportConfig(s) linked to measurement objects. If all configured events are based on triggerQuantity=RSRQ, the UE shall start measuring RSRQ. Otherwise, if all configured events are based on triggerQuantity=RSRP, the UE shall start to perform measurements based on RSRP. Else, if there are events based on triggerQuantity=RSRP and events based on triggerQuantity=RSRP, the UE shall perform RSRP and RSRQ measurements.

Multiple s-Measures

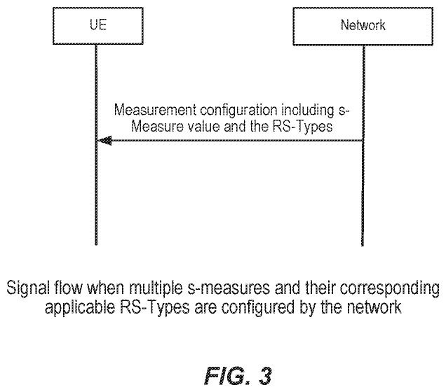

In a fifth example embodiment, the network can configure multiple s-Measure thresholds, one per each of two or more measurement quantities (e.g., RSRP, RSRQ, SINR, etc.). The signal flow is shown by FIG. 3. There can be two parameters, where each of them is optional. That is, the network can configure the following combinations with respective thresholds:
RSRP only, i.e., s-Measure(RSRP);
RSRQ only, i.e., s-Measure(RSRQ);
SINR only, s-Measure(SINR);
RSRQ and RSRP, i.e., s-Measure(RSRQ) and s-Measure(RSRP);
RSRQ and SINR, i.e., s-Measure(RSRQ) and s-Measure(SINR);
RSRP and SINR, i.e., s-Measure(RSRQ) and s-Measure(SINR); or
RSRP, RSRQ and SINR i.e., s-Measure(RSRP), s-Measure(RSRQ) and s-Measure(SINR).

Based on the different possible configurations for multiple measurement quantities, there could be different UE actions. If the UE is configured with an s-Measure for RSRP and another s-Measure for RSRQ, for example, the UE shall perform serving cell (e.g., PCell) measurements on RSRP (e.g., RSRP measurements) and RSRQ and act as follows:
a) If PCell RSRP<s-Measure(RSRP), the UE shall perform RSRP neighbor cell RSRP measurements if these are configured;
b) If PCell RSRP<s-Measure(RSRP), the UE shall perform neighbor RSRP and RSRQ cell measurements;
c) If PCell RSRP<s-Measure(RSRP) OR if PCell RSRQ<s-Measure(RSRQ), the UE shall perform RSRP neighbor cell measurements;
d) If PCell RSRP<s-Measure(RSRP) OR if PCell RSRQ<s-Measure(RSRQ), the UE shall perform RSRP and RSRQ neighbor cell measurements; or
e) If PCell RSRP<s-Measure(RSRP) AND if PCell RSRQ<s-Measure(RSRQ), the UE shall perform RSRP and RSRQ neighbor cell measurements.

The network can configure any combination of these or a subset of combinations.

The previously described conditions may also be extended to trigger other types of neighbor cell measurements. For example, the UE can be triggered to start Layer 3-filtered beam measurements associated with neighbor cells.

In some embodiments, the network can configure multiple s-Measure thresholds, one per RS type. In this scenario, the network can provide both an s-Measure threshold value and an RS Type associated to it as shown in the signal flow graph of FIG. 3. There can be two parameters, where each of them is optional. That is, the network can configure the combination SS+CSI-RS, SS only, CSI-RS only or nothing.

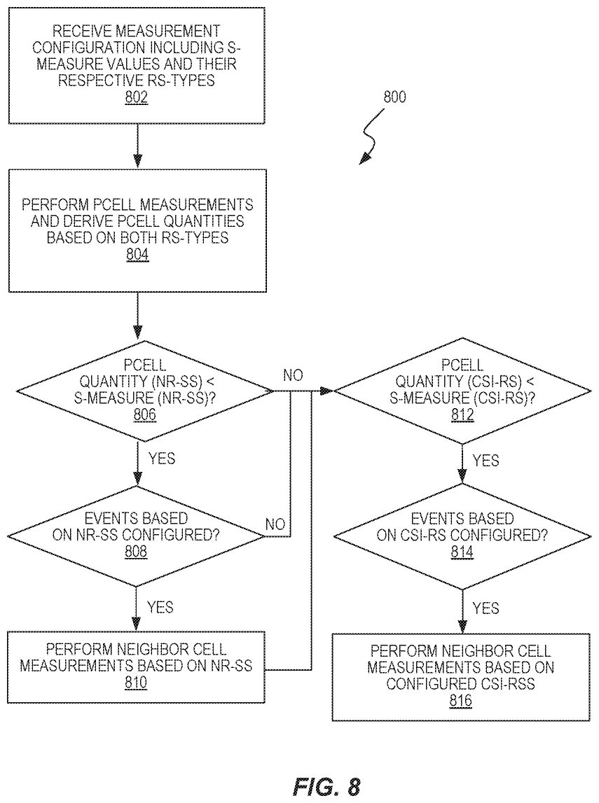

Based on the different possible configurations for NR-SS and CSI-RS there could be different UE actions. FIG. 8 illustrates an example flowchart for some of these actions. If the UE is configured with an s-Measure for NR-SS and another s-Measure for CSI-RS (block 802), the UE shall perform serving cell (e.g., PCell) measurements on NR-SS (e.g., RSRP measurements) and CSI-RS (block 804) and act as follows:
a) If PCell RSRP based on CSI-RS<s-Measure(CSI-RS) (decision 812), the UE shall perform neighbor cell measurements based on CSI-RS if these are configured (block 816);
b) If PCell RSRP based on NR-SS<s-Measure(NR-SS) (decision 806), the UE shall perform neighbor cell measurements based on NR-SS Block if these are configured (block 810);
c) If PCell RSRP based NR-SS<s-Measure(NR-SS) OR if PCell RSRP based on CSI-RS<s-Measure(CSI-RS), the UE shall perform neighbor cell measurements (based on both NR-SS and CSI-RS if these are configured);
d) If PCell RSRP based on NR-SS<s-Measure(NR-SS) AND if PCell based on CSI-RS<s-Measure (CSI-RS), the UE shall perform neighbor cell measurements (based on both NR-SS and CSI-RS if these are configured);
e) The network can configure a), b) or c);
f) The network can configure a), b) or d); or
g) The network can configure a), b), c) or d).

This process may also consider whether events based on certain RS Types, such as NR-SS or CSI-RS, are configured (decisions 808 and 814). The previously described conditions may also be extended to trigger other types of neighbor cell measurements. For example, that can trigger the UE to start L3 filtered beam measurements associated to neighbor cells.

Accordingly, the processing circuit 52 is also configured to perform a method based on signal quantities, such as RSRP, RSRQ, SINR, etc., rather than signal types. In these embodiments, the processing circuit 52 is configured to receive a first parameter indicating a first threshold value, the first threshold value being associated with signal measurements performed using a first measurement signal quantity of a plurality of measurement signal quantities that can be determined by the wireless device. The processing circuit 52 is configured to perform a signal measurement of the first measurement signal quantity on transmissions from a serving cell, to obtain a first signal measurement value, and determine whether to perform measurements on transmission from neighbor cells, based on whether the first signal measurement value is below the first threshold value. The processing circuit 52 is also configured to, responsive to determining that the first signal measurement value is below the first threshold value, perform configured measurements on transmission from one or more neighbor cells, using one or more of the plurality of measurement signal quantities based on one or more configured measurement event triggers.

The processing circuit 52 is also configured to perform a corresponding method 900. The method 900 includes receiving a first parameter indicating a first threshold value, the first threshold value being associated with signal measurements performed using a first measurement signal quantity of a plurality of measurement signal quantities that can be determined by the wireless device (block 902). The method 900 also includes performing a signal measurement of the first measurement signal quantity on transmissions from a serving cell, to obtain a first signal measurement value (block 904). The method 900 further includes determining whether to perform measurements on transmission from neighbor cells, based on whether the first signal measurement value is below the first threshold value (block 906). The method 900 then includes, responsive to determining that the first signal measurement value is below the first threshold value, performing configured measurements on transmission from one or more neighbor cells, using one or more of the plurality of measurement signal quantities based on one or more configured measurement event triggers (block 908).

The first parameter may apply to any of a plurality of reference signal types that can be used by the wireless device for signal measurements or to a first reference signal type of the plurality of reference signal types. The plurality of signal measurement quantities may include reference signal received power signal quantity and a reference signal received power quantity.

The method 900 may include receiving, prior to performing said signal measurement on transmissions from the serving cell, configuration information indicating the applicability of the first parameter to the first reference signal type. The plurality of reference signal types may include at least cell-specific reference symbols and synchronization signals.

The method 900 may include receiving, prior to performing said signal measurement on transmissions from the serving cell, configuration information indicating the first signal measurement quantity associated with the first parameter.

In some cases, performing the configured measurements on transmission from one or more neighbor cells may include performing measurements according to a different one of the plurality of signal measurement quantities from the first signal measurement quantity.

The method 900 may also include receiving a second parameter indicating a second threshold value, the second threshold value being associated with signal measurements performed using a second measurement signal quantity of the plurality of measurement signal quantities that can be determined by the wireless device. The method 900 may then include performing a signal measurement of the second measurement signal quantity on transmissions from a serving cell, to obtain a second signal measurement value. The performing of the configured measurements on transmission from one or more neighbor cells may be responsive to determining both that the first signal measurement value is below the first threshold value and that the second signal measurement value is below the second threshold.

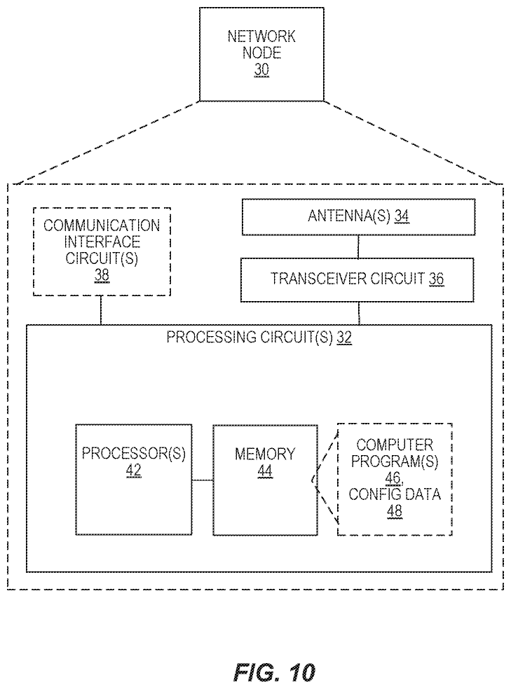

FIG. 10 illustrates a diagram of a network node 30 that may be configured to carry out one or more of these disclosed techniques from the perspective of an access node of the wireless communications network. The network node 30 can be any kind of network access node, such as a base station, radio base station, base transceiver station, evolved Node B (eNodeB), Node B, or relay node. In the non-limiting embodiments described below, the network node 30 will be described as being configured to operate as a cellular network access node in an LTE network or NR network.

Those skilled in the art will readily appreciate how each type of node may be adapted to carry out one or more of the methods and signaling processes described herein, e.g., through the modification of and/or addition of appropriate program instructions for execution by processing circuits 32.

The network node 30 facilitates communication between wireless terminals, other network access nodes and/or the core network. The network node 30 may include a communication interface circuit 38 that includes circuitry for communicating with other nodes in the core network, radio nodes, and/or other types of nodes in the network for the purposes of providing data and/or cellular communication services. The network node 30 communicates with wireless devices using antennas 34 and a transceiver circuit 36. The transceiver circuit 36 may include transmitter circuits, receiver circuits, and associated control circuits that are collectively configured to transmit and receive signals according to a radio access technology, for the purposes of providing cellular communication services.

The network node 30 also includes one or more processing circuits 32 that are operatively associated with the transceiver circuit 36 and, in some cases, the communication interface circuit 38. For ease of discussion, the one or more processing circuits 32 are referred to hereafter as “the processing circuit 32” or “the processing circuitry 32.” The processing circuit 32 comprises one or more digital processors 42, e.g., one or more microprocessors, microcontrollers, DSPs, FPGAs, CPLDs, ASICs, or any mix thereof. More generally, the processing circuit 32 may comprise fixed circuitry, or programmable circuitry that is specially configured via the execution of program instructions implementing the functionality taught herein, or may comprise some mix of fixed and programmed circuitry. The processor 42 may be multi-core, i.e., having two or more processor cores utilized for enhanced performance, reduced power consumption, and more efficient simultaneous processing of multiple tasks.

The processing circuit 32 also includes a memory 44. The memory 44, in some embodiments, stores one or more computer programs 46 and, optionally, configuration data 48. The memory 44 provides non-transitory storage for the computer program 46 and it may comprise one or more types of computer-readable media, such as disk storage, solid-state memory storage, or any mix thereof. By way of non-limiting example, the memory 44 comprises any one or more of SRAM, DRAM, EEPROM, and FLASH memory, which may be in the processing circuit 32 and/or separate from the processing circuit 32. The memory 44 may also store any configuration data 48 used by the network access node 30. The processing circuit 32 may be configured, e.g., through the use of appropriate program code stored in memory 44, to carry out one or more of the methods and/or signaling processes detailed hereinafter.

The processing circuit 32 of the network node 30 is configured, according to some embodiments, to configure the LIE as described in various embodiments herein or to provide any of the parameters or thresholds discussed herein or shown by the signal flows of FIGS. 1-3.

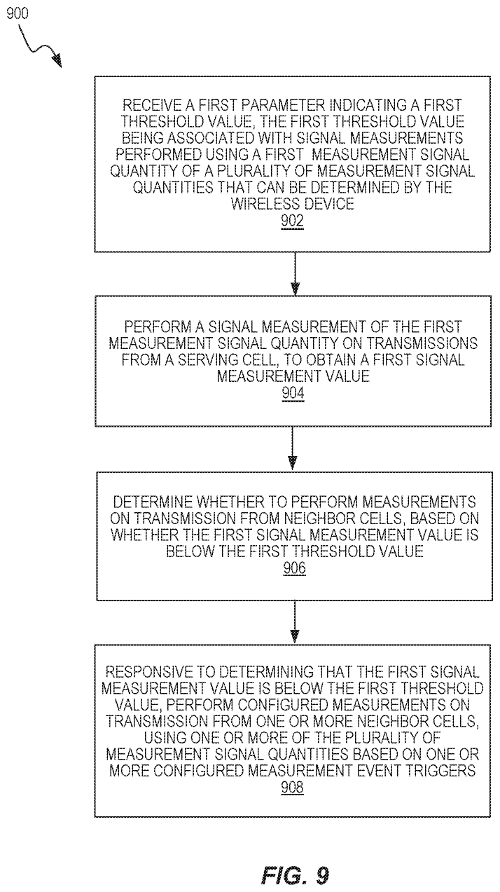

As discussed in detail above, the techniques described herein, e.g., as illustrated in the process flow diagrams of FIGS. 5 and 9, may be implemented, in whole or in part, using computer program instructions executed by one or more processors. It will be appreciated that a functional implementation of these techniques may be represented in terms of functional modules, where each functional module corresponds to a functional unit of software executing in an appropriate processor or to a functional digital hardware circuit, or some combination of both.

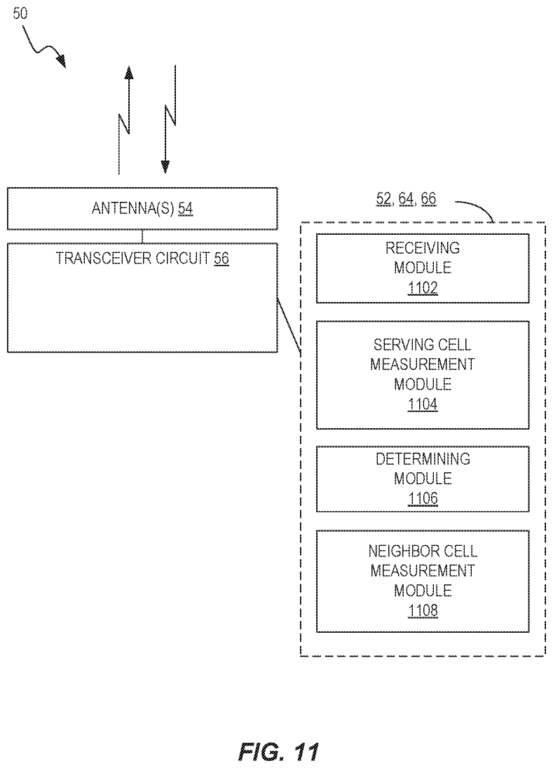

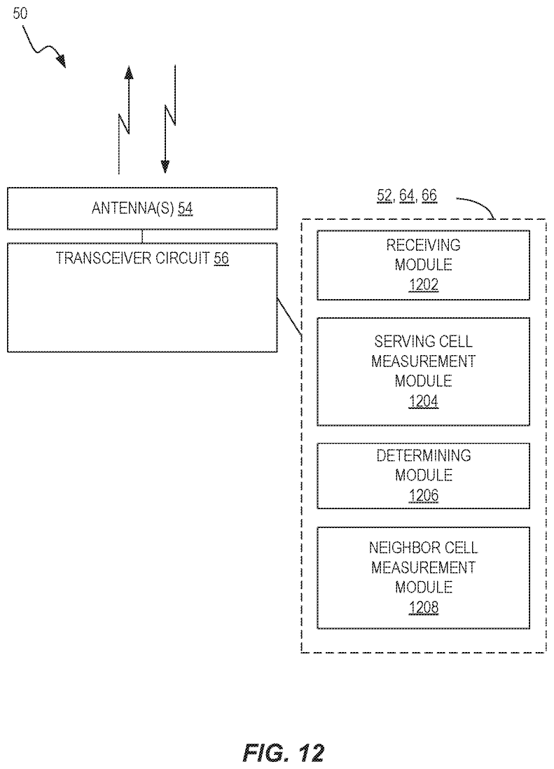

FIG. 11 illustrates an example functional module or circuit architecture as may be implemented in a wireless device, such as in the wireless device 50. The functional implementation includes a receiving module 1102 for receiving a first parameter indicating a first threshold value, where the first threshold value is associated with signal measurements performed using a first reference signal type of a plurality of reference signal types that the wireless device can measure. The implementation also includes a serving cell measurement module 1104 for performing a signal measurement on transmissions from a serving cell, using the first reference signal type, to obtain a first signal measurement value, and a determining module 1106 for determining whether to perform measurements on transmission from neighbor cells, based on whether the first signal measurement value is below the first threshold value. The implementation includes a neighbor cell measurement module 1108 for, responsive to determining that the first signal measurement value is below the first threshold value, performing configured measurements on transmission from one or more neighbor cells, using one or more of the plurality of reference signal types based on one or more configured measurement event triggers.

FIG. 12 illustrates an example functional module or circuit architecture as may be implemented in a wireless device, such as in the wireless device 50. The functional implementation includes a receiving module 1202 for receiving a first parameter indicating a first threshold value, where the first threshold value is associated with signal measurements performed using a first measurement signal quantity of a plurality of measurement signal quantities that can be determined by the wireless device. The implementation also includes a serving cell measurement module 1204 for performing a signal measurement of the first measurement signal quantity on transmissions from a serving cell, to obtain a first signal measurement value. The implementation further includes a determining module 1206 for determining whether to perform measurements on transmission from neighbor cells, based on whether the first signal measurement value is below the first threshold value, and, a measurement neighbor cell measurement module 1208 for responsive to determining that the first signal measurement value is below the first threshold value, performing configured measurements on transmission from one or more neighbor cells, using one or more of the plurality of measurement signal quantities based on one or more configured measurement event triggers.

The present invention may, of course, be carried out in other ways than those specifically set forth herein without departing from essential characteristics of the invention. The present embodiments are to be considered in all respects as illustrative and not restrictive.

1-43. (canceled)

44. A method, in a wireless device, the method comprising:
receiving a first parameter indicating a first threshold value, the first threshold value being associated with signal measurements performed using a first reference signal type of a plurality of reference signal types that the wireless device can measure;
performing a signal measurement on transmissions from a serving cell, using the first reference signal type, to obtain a first signal measurement value;
determining whether to perform measurements on transmission from neighbor cells, based on whether the first signal measurement value is below the first threshold value; and,
responsive to determining that the first signal measurement value is below the first threshold value, performing configured measurements on transmission from one or more neighbor cells, using one or more of the plurality of reference signal types based on one or more configured measurement event triggers.

45. The method of claim 44, wherein the method further comprises receiving, prior to performing said signal measurement on transmissions from the serving cell, configuration information indicating that the first reference signal type is associated with the first parameter.

46. The method of claim 44, wherein the first parameter applies to at least a first signal measurement quantity of a plurality of signal measurement quantities that can be determined by the wireless device.

47. The method of claim 44, further comprising:
receiving a second parameter indicating a second threshold value, the second threshold value being associated with signal measurements performed using a second reference signal type of the plurality of reference signal types that the wireless device can measure; and
performing a signal measurement using the second reference signal type on transmissions from a serving cell, to obtain a second signal measurement value;
wherein performing the configured measurements on transmission from one or more neighbor cells is responsive to determining both that the first signal measurement value is below the first threshold value and that the second signal measurement value is below the second threshold.

48. A method, in a wireless device, the method comprising:
receiving a first parameter indicating a first threshold value, the first threshold value being associated with signal measurements performed using a first measurement signal quantity of a plurality of measurement signal quantities that can be determined by the wireless device;
performing a signal measurement of the first measurement signal quantity on transmissions from a serving cell, to obtain a first signal measurement value;
determining whether to perform measurements on transmission from neighbor cells, based on whether the first signal measurement value is below the first threshold value; and,
responsive to determining that the first signal measurement value is below the first threshold value, performing configured measurements on transmission from one or more neighbor cells, using one or more of the plurality of measurement signal quantities based on one or more configured measurement event triggers.

49. The method of claim 48, wherein the first parameter applies to at least a first reference signal type of a plurality of reference signal types that can be used by the wireless device for signal measurements.

50. The method of claim 49, wherein the method further comprises receiving, prior to performing said signal measurement on transmissions from the serving cell, configuration information indicating the applicability of the first parameter to the first reference signal type.

51. The method of claim 48, wherein the method further comprises receiving, prior to performing said signal measurement on transmissions from the serving cell, configuration information indicating that the first signal measurement quantity is associated with the first parameter.

52. The method of claim 48, further comprising:
receiving a second parameter indicating a second threshold value, the second threshold value being associated with signal measurements performed using a second measurement signal quantity of the plurality of measurement signal quantities that can be determined by the wireless device; and
performing a signal measurement of the second measurement signal quantity on transmissions from a serving cell, to obtain a second signal measurement value;
wherein performing the configured measurements on transmission from one or more neighbor cells is responsive to determining both that the first signal measurement value is below the first threshold value and that the second signal measurement value is below the second threshold.

53. A wireless device, comprising:
transceiver circuitry configured for receiving transmissions; and
processing circuitry operatively associated with the transceiver circuitry and configured to:
receive a first parameter indicating a first threshold value, the first threshold value being associated with signal measurements performed using a first reference signal type of a plurality of reference signal types that the wireless device can measure;
perform a signal measurement on transmissions from a serving cell, using the first reference signal type, to obtain a first signal measurement value;
determine whether to perform measurements on transmission from neighbor cells, based on whether the first signal measurement value is below the first threshold value; and,
responsive to determining that the first signal measurement value is below the first threshold value, perform configured measurements on transmission from one or more neighbor cells, using one or more of the plurality of reference signal types based on one or more configured measurement event triggers.

54. The wireless device of claim 53, wherein the processing circuitry is configured to receive, prior to performing said signal measurement on transmissions from the serving cell, configuration information indicating that the first reference signal type is associated with the first parameter.

55. The wireless device of embodiment claim 53, wherein the first parameter applies to any of a plurality of signal measurement quantities that can be determined by the wireless device.

56. The wireless device of claim 55, wherein the plurality of signal measurement quantities includes at least a reference signal received power signal quantity and a reference signal received power quantity.

57. The wireless device of embodiment claim 53, wherein the first parameter applies to a first signal measurement quantity of a plurality of signal measurement quantities that can be determined by the wireless device.

58. The wireless device of claim 57, wherein the processing circuitry is further configured to receive, prior to performing said signal measurement on transmissions from the serving cell, configuration information indicating the applicability of the first parameter to the first signal measurement quantity.

59. The wireless device of claim 53, wherein the plurality of reference signal types includes cell-specific reference symbols and synchronization signals.

60. The wireless device of claim 53, wherein the processing circuitry is configured to perform said configured measurements on transmission from one or more neighbor cells by performing measurements using a different one of the plurality of reference signal types from the first reference signal type.

61. The wireless device of claim 53, wherein the processing circuitry is configured to:
receive a second parameter indicating a second threshold value, the second threshold value being associated with signal measurements performed using a second reference signal type of the plurality of reference signal types that the wireless device can measure; and
perform a signal measurement using the second reference signal type on transmissions from a serving cell, to obtain a second signal measurement value;
wherein the processing circuitry is configured to perform the configured measurements on transmission from one or more neighbor cells responsive to determining both that the first signal measurement value is below the first threshold value and that the second signal measurement value is below the second threshold.

62. A wireless device, comprising:
transceiver circuitry configured for receiving transmissions; and
processing circuitry operatively associated with the transceiver circuitry and configured to:
receive a first parameter indicating a first threshold value, the first threshold value being associated with signal measurements performed using a first measurement signal quantity of a plurality of measurement signal quantities that can be determined by the wireless device;
perform a signal measurement of the first measurement signal quantity on transmissions from a serving cell, to obtain a first signal measurement value;
determine whether to perform measurements on transmission from neighbor cells, based on whether the first signal measurement value is below the first threshold value; and,
responsive to determining that the first signal measurement value is below the first threshold value, perform configured measurements on transmission from one or more neighbor cells, using one or more of the plurality of measurement signal quantities based on one or more configured measurement event triggers.

63. The wireless device of claim 62, wherein the processing circuitry is configured to receive, prior to performing said signal measurement on transmissions from the serving cell, configuration information indicating that the first signal measurement quantity is associated with the first parameter.

64. The wireless device of claim 62, wherein the first parameter applies to any of a plurality of reference signal types that can be used by the wireless device for signal measurements.

65. The wireless device of claim 64, wherein the plurality of reference signal types includes at least cell-specific reference symbols and synchronization signals.

66. The wireless device of claim 62, wherein the first parameter applies to a first reference signal type of a plurality of reference signal types that can be used by the wireless device for signal measurements.

67. The wireless device of claim 66, wherein the processing circuitry is configured to receive, prior to performing said signal measurement on transmissions from the serving cell, configuration information indicating the applicability of the first parameter to the first reference signal type.

68. The wireless device of claim 62, wherein the plurality of signal measurement quantities includes reference signal received power signal quantity and a reference signal received power quantity.

69. The wireless device of claim 62, wherein the processing circuitry is configured to perform said configured measurements on transmission from one or more neighbor cells by performing measurements according to a different one of the plurality of signal measurement quantities from the first signal measurement quantity.

70. The wireless device of claim 62, wherein the processing circuitry is configured to:
receive a second parameter indicating a second threshold value, the second threshold value being associated with signal measurements performed using a second measurement signal quantity of the plurality of measurement signal quantities that can be determined by the wireless device; and
perform a signal measurement of the second measurement signal quantity on transmissions from a serving cell, to obtain a second signal measurement value;
wherein the processing circuitry is configured to perform the measurements on transmission from one or more neighbor cells responsive to determining both that the first signal measurement value is below the first threshold value and that the second signal measurement value is below the second threshold.
